(19) United States
(12) Patent Application Publication
(10) Pub. No.: US 2010/0288926 A1
(43) Pub. Date: Nov. 18, 2010

(54) ATOM PROBE DATA AND ASSOCIATED SYSTEMS AND METHODS

(76) Inventors: Scott A. Wiener, Mount Horeb, WI (US); Thomas F. Kelly, Madison, WI (US); David J. Larson, Madison, WI (US); Keith J. Thompson, Fitchburg, WI (US); Robert M. Ulfig, Middleton, WI (US); Brian P. Geiser, Madison, WI (US); Thomas C. Kunicki, Madison, WI (US); Raymond W. O'Neill, Philadelphia, PA (US); Jason Schneir, Madison, WI (US)

Correspondence Address: PERKINS COIE LLP;PATENT-SEA, P.O. BOX 1247, SEATTLE, WA, 98111-1247, US

(21) Appl. No.: 12/294,716

(22) PCT Filed: Mar. 27, 2007
(86) PCT No.: PCT/US07/65275

§ 371 Date: Sep. 26, 2008

Related U.S. Application Data
(60) Provisional application No. 60/786,148, filed on Mar. 27, 2006.
(60) Provisional application No. 60/786,295, filed on Mar. 27, 2006.
(60) Provisional application No. 60/786,317, filed on Mar. 27, 2006.

(51) Int. Cl. G01B 21/30

(52) U.S. Cl. 250/309

(57) ABSTRACT

The present invention relates to atom probe data and associated systems and methods. Aspects of the invention are directed toward a computing system configured to predict a characteristic associated with an atom probe specimen that includes a data set receiving component configured to receive a three-dimensional data set associated with a portion of the specimen. The system further includes a predicting/calculating component configured to predict the characteristic associated with the specimen based on the data set. Other aspects of the invention are directed toward a method for evaluating a manufacturing process using atom probe data that includes receiving a three-dimensional data set associated with a portion of a microelectronic assembly produced by a manufacturing process. The method further includes determining a variation between the data set and a configuration expected to result from the manufacturing process.

### CROSS-REFERENCE TO RELATED APPLICATION(S)

This application claims the benefit of U.S. Provisional Patent Application No. 60/786,317, filed Mar. 27, 2006, entitled ATOM PROBE SYSTEMS AND PROCESSES, U.S. Provisional Patent Application No. 60/786,148, filed Mar. 27, 2006, entitled ATOM PROBE MEASUREMENTS, INCLUDING THOSE RELATED TO SURFACE ROUGHNESS, and U.S. Provisional Patent Application No. 60/786,295, filed Mar. 27, 2006, entitled ATOM PROBES AND ATOM PROBE DATA, each of which is fully incorporated herein by reference.

### TECHNICAL FIELD

Embodiments of the present invention relate to atom probe data and associated systems and methods.

### BACKGROUND

An atom probe (e.g., atom probe microscope) is a device which allows specimens to be analyzed on an atomic level. For example, a typical atom probe includes a specimen mount, an electrode, and a detector. During analysis, a specimen is carried by the specimen mount and a positive electrical charge (e.g., a baseline voltage) is applied to the specimen. The detector is spaced apart from the specimen and is negatively charged. The electrode is located between the specimen and the detector, and is either grounded or negatively charged. A positive electrical pulse (above the baseline voltage) and/or a laser pulse (e.g., photonic energy) are intermittently applied to the specimen. Alternately, a negative pulse can be applied to the electrode. Occasionally (e.g., one time in 100 pulses) a single atom is ionized near the tip of the specimen. The ionized atom(s) separate or “evaporate” (e.g., field evaporate) from the surface, pass though an aperture in the electrode, and impact the surface of the detector. The elemental identity of an ionized atom can be determined by measuring its time of flight between the surface of the specimen and the detector, which varies based on the mass/charge ratio of the ionized atom. The location of the ionized atom on the surface of the specimen can be determined by measuring the location of the atom's impact on the detector. Accordingly, as the specimen is evaporated, a three-dimensional map of the specimen's constituents can be constructed.

### SUMMARY

The present invention is directed generally toward atom probe data and associated systems and methods. Aspects of the invention are directed toward a computing system configured to predict a characteristic associated with an atom probe specimen that includes a data set receiving component configured to receive a three-dimensional data set. The three-dimensional data set is based on data collected from performing an atom probe process on a portion of the specimen. The system further includes a predicting/calculating component configured to predict the characteristic associated with at least part of the portion of the specimen based on the three-dimensional data set. The characteristic is different than the three-dimensional data set.

Other aspects of the invention are directed toward a computing system configured to calculate a surface roughness metric associated with a specimen that includes a data set receiving component configured to receive a three-dimensional data set. The three-dimensional data set is based on data collected from performing an atom probe process on a portion of the specimen. The system further includes a calculating component configured to calculate the surface roughness metric associated with a surface of the specimen based on the three-dimensional data set.

Still other aspects of the invention are directed toward a method for evaluating a manufacturing process using atom probe data that includes receiving a three-dimensional data set. The three-dimensional data set is based on data collected from performing an atom probe process on a portion of a specimen. The specimen is a portion of a microelectronic assembly produced by a manufacturing process. The method further includes determining a variation between the three-dimensional data set and a selected configuration expected to result from the manufacturing process.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a partially schematic illustration of an atom probe device that in accordance with embodiments of the invention.

FIG. 2 is partially schematic illustration of a structure having a portion to be analyzed via an atom probe process in accordance with certain embodiments of the invention.

FIG. 3 is a partially schematic illustration of an atom probe specimen prepared from the portion of the structure shown in FIG. 2, in accordance with selected embodiments of the invention.

FIG. 4 is a partially schematic illustration of the computing system shown in FIG. 1 in accordance with selected embodiments of the invention.

FIG. 5 is a flow diagram illustrating a method for predicting a characteristic associated with an atom probe specimen in accordance with certain embodiments of the invention.

FIG. 6 is a flow diagram illustrating a method for evaluating a manufacturing process using atom probe data in accordance with selected embodiments of the invention.

FIG. 7 is a partially schematic illustration of a three-dimensional map in accordance with certain embodiments of the invention.

FIG. 8 is a partially schematic illustration of a portion of a three-dimensional numerical array in accordance with another embodiment of the invention.

### DETAILED DESCRIPTION

In the following description, numerous specific details are provided in order to give a thorough understanding of embodiments of the invention. One skilled in the relevant art will recognize, however, that the invention may be practiced without one or more of the specific details, or with other methods, components, materials, etc. In other instances, well known structures, materials, or operations are not shown or described in order to avoid obscuring aspects of the invention.

References throughout the specification to “one embodiment” or “an embodiment” means that a particular feature, structure, or characteristic described in connection with the embodiment is included in at least one embodiment of the present invention. Thus, the appearances of the phrase “in one embodiment” or “in an embodiment” in various places throughout the specification are not necessarily all referring to the same embodiment. Furthermore, the particular features, structures, or characteristics may be combined in any suitable manner in one or more embodiments.

Accordingly, various embodiments of the invention are described below. First, the structure and operation of atom probe devices are discussed. Then, various systems and methods for using atom probe data are described.

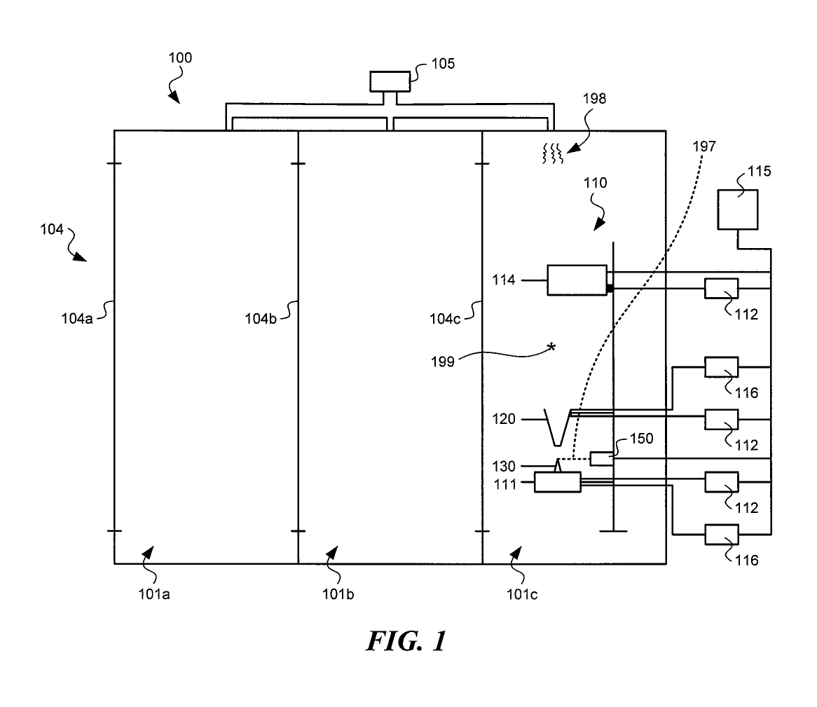

FIG. 1 is a partially schematic illustration of an atom probe device 100 in accordance with embodiments of the invention. In the illustrated embodiment, the atom probe device 100 includes a load lock chamber 101a, a buffer chamber 101b, and an analysis chamber 101c (shown collectively as chambers 101). The atom probe device 100 also includes a computing system 115 and an atom probe assembly 110 having a specimen mount 111, an atom probe electrode 120, a detector 114, and an emitting device 150 (e.g., an emitting device configured to emit laser or photonic energy). The mount 111, electrode 120, and detector 114 can be operatively coupled to electrical sources 112. The electrode 120 and mount 111 can also be operatively coupled to temperature control devices 116 (e.g., cold/hot fingers that can provide contact cooling/heating to the atom probe electrode 120 and/or a specimen 130 carried by the mount 111). The emitting device 150, the detector 114, the voltage sources 112, and the temperature control devices 116 can be operatively coupled to the computing system 115, which can control the analysis process, atom probe device operation, data analysis, image display, and/or other types of data manipulation.

In the illustrated embodiment, each chamber 101 is operatively coupled to a fluid control system 105 (e.g., a vacuum pump, turbo molecular pump, and/or an ion pump) that is capable of lowering the pressure in the chambers 101 individually. Additionally, the atom probe device 100 can include sealable passageways 104 (e.g., gate valves) positioned in the walls of the chambers 101 that allow items to be placed in, removed from, and/or transferred between the chambers 101. In the illustrated embodiment, a first passageway 104a is positioned between the interior of the load lock chamber 101a and the exterior of the atom probe device 100, a second passageway 104b is positioned between the interior of the load lock chamber 101a and the interior of the buffer chamber 101b, and a third passageway 104c is positioned between the interior of the buffer chamber 101b and the interior of the analysis chamber 101c.

In FIG. 1, a specimen can be placed in the load lock chamber 101a via the first passageway 104a. All of the passageways 104 can be sealed and the fluid control system 105 can lower the pressure in the load lock chamber 101a (e.g., reduce the pressure to 10⁻⁶-10⁻⁷ torr). The pressure in the buffer chamber 101b can be set at approximately the same or a lower pressure than the load lock chamber 101a. The second passageway 104b can be opened, the specimen 130 can be transferred to the buffer chamber 101b, and the second and third passageways 104b and 104c can be sealed.

The fluid control system 105 can then lower the pressure in the buffer chamber 101b (e.g., reduce the pressure to 10⁻⁸-10⁻⁹ torr). The pressure in the analysis chamber 101c can be set at approximately the same or a lower pressure than the buffer chamber 101b. The third passageway 104c can be opened, the specimen 130 can be transferred to the analysis chamber 101c, and the third passageway 104c can be sealed. The fluid control system 105 can then reduce the pressure in the analysis chamber 101c (e.g., the pressure can be lowered to 10⁻¹⁰-10⁻¹¹ torr) prior to analysis of the specimen 130. In the illustrated embodiment, the fluid control system 105 can also be used to introduce selected fluids 198 (e.g., gases and/or liquid) and/or to control the composition of fluid in various atom probe chambers 101.

During analysis of the specimen 130, a positive electrical charge (e.g., a bias voltage or bias energy) can be applied to the specimen. The detector can be grounded or negatively charged and the electrode can be either grounded or negatively charged. A positive electrical pulse (e.g., an increase above the baseline energy or voltage) can be intermittently applied to the specimen 130 or a negative electrical pulse can be applied to the electrode 120. The electric field(s) created by the electrical charges can provide energy to ionize one or more atom(s) on the surface of the specimen 130. These ionized atom(s) 199 can separate or “evaporate” (e.g., field-evaporated by the bias energy and/or the pulse energy) from the surface, pass through an aperture in the electrode 120, and impact the surface of the detector 114. As the specimen 130 is evaporated, a three-dimensional map of the specimen's constituents can be constructed (e.g., an image or compositional image can be created), for example, via data analysis and/or the computing system 115. In other embodiments, the bias energy can include the energy difference (e.g., electrical potential and/or other type(s) of energy differential) between the specimen and the detector and/or the electrode when no pulse energy is present.

In certain embodiments, laser or photonic energy from the emitting device 150 can be used to emit an emission 197 (e.g., photons or laser light) to thermally pulse a portion of the specimen 130 to assist with the evaporation process (e.g., the removal of ionized atoms). This laser pulse can be in lieu of the electrical pulse discussed above or in addition to the electrical pulse. The total energy above the bias energy (e.g., a photonic energy pulse such as a laser pulse, an electrical pulse, an electron beam or packet, an ion beam, or some other suitable pulsed energy source) represents the pulse energy. The rate at which the pulse energy is applied is the pulse frequency.

As discussed above, the computing system 115 can control the analysis process, atom probe device operation, data analysis, image display, and/or other types of data manipulation (e.g., using the data to predict a characteristic associated with a specimen and/or to evaluate a manufacturing/production process). The computing device or computing system 115 may include a central processing unit, memory, input devices (e.g., keyboard and pointing devices), output devices (e.g., display devices), and storage devices (e.g., disk drives). The memory and storage devices can be computer-readable media that may be encoded with computer-executable instructions that implement the system (e.g., a computer-readable medium that contains the instructions). Additionally, in selected embodiments memory and storage devices can be encoded with data (e.g., data collected from an atom probe process, data used in processing the atom probe data, and/or data used in conjunction with the atom probe data). Furthermore, the data structures and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the system may be implemented in various operating environments that include personal computers, server computers, handheld or laptop devices, multiprocessor systems, microprocessor-based systems, programmable consumer electronics, digital cameras or other types of imagers, network PCs, minicomputers, mainframe computers, distributed computing environments that include any of the above systems or devices, and so on. The system may also be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments. For example, in certain embodiments a portion of computer-executable instructions can be executed on a selected computer, data can be transferred to another computer (e.g., via a network connection or via a portable computer readable medium such as a disk), and one or more additional portions of the computer-executable instructions can be performed on the data by the other computer.

In other embodiments, the atom probe device 100 can have more, fewer, and/or other arrangements of components. For example, in certain embodiments the atom probe device 100 can include more or fewer chambers, or no chambers. In other embodiments, the atom probe device can include multiple atom probe electrodes 120 and/or electrode(s) 120 having different configurations/placements (e.g., planar electrode(s)). In still other embodiments, the atom probe device 100 includes more, fewer, or different emitting devices 150; more, fewer, or different temperature control systems 116; and/or more, fewer or different electrical sources 112.

In selected embodiments, an atom probe process can be used to evaporate at least a portion of a specimen (e.g., formed from a portion of a structure). Data gathered during the evaporation process can be used to construct or form a three-dimensional data set and the data set can be used to predict a characteristic of the specimen or to evaluate a manufacturing process used to form the structure. As used herein, a three-dimensional data set can include a three-dimensional representation of the arrangement of atoms and/or molecules that were in/on the portion of the specimen that was evaporated and can include the type of atoms/molecules (e.g., compositional data), the position or location of atoms/molecules, and/or the number of atoms/molecules. In certain embodiments, this process can be particularly useful in predicting characteristics of complex structures (e.g., microstructures) and/or the process used to manufacture those structures.

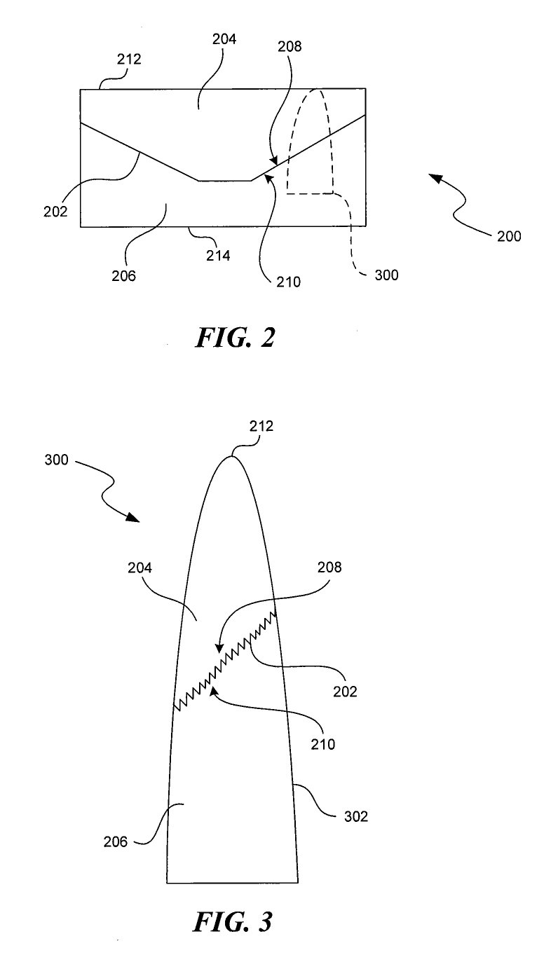

For example, FIG. 2 is partially schematic illustration of a structure 200 having a portion 300 to be analyzed via an atom probe process in accordance with certain embodiments of the invention. In FIG. 2, the structure 200 includes a microelectronic assembly with a first layer 204 that has a first surface 208 and a second surface 212, and a second layer 206 that has a first surface 210 and a second surface 214. In selected embodiments the first layer 204 and the second layer 206 can include different materials. In other embodiments, the first and second layers 204 and 206 can include the same materials, but have other distinguishing characteristics. In the illustrated embodiment, the first surface 208 of the first layer 204 and the first surface 210 of the second layer 206 are carried in the interior of the microelectronic assembly and abut one another to form an interface 202 between the first and second layers 204 and 206. In FIG. 2, the second surface 212 of the first layer 204 and the second surface 214 of the second layer 206 are carried on the exterior of microelectronic assembly. In other embodiments, the microelectronic assembly can include more or fewer internal surfaces, external surfaces, interfaces, and/or layers (e.g., including being a homogeneous structure).

In FIG. 2, the microelectronic assembly includes substrates that are used to form microelectronic devices. Typical microdevices include microelectronic circuits or components, thin-film recording heads, data storage elements, microfluidic devices, and other products. Micromachines and micromechanical devices are included within this definition because they are manufactured using much of the same technology that is used in the fabrication of integrated circuits. The substrates can be semiconductive pieces (e.g., doped silicon wafers, silicon germanium wafers, or gallium arsenide wafers), non-conductive pieces (e.g., various ceramic substrates), or conductive pieces. In some cases, the substrates can include flexible materials (e.g., flexible tape) and/or rigid materials. In selected embodiments a microelectronic device can include a semiconductor wafer or die. In other embodiments, the structure 200 can include structures other than a microelectronic assembly (e.g., various types of assemblies and/or materials including other types of devices, composite materials, biological materials, and/or the like).

FIG. 3 is a partially schematic illustration of an atom probe specimen 302 prepared from the portion 300 of the structure 200 shown in FIG. 2. In FIG. 3, the specimen 302 internally carries a portion of the interface 202 formed by the first internal surface 208 of the first layer 204 and the first internal surface 210 of the second layer 206. The portion 300 has been enlarged in FIG. 3 to better show the interface 202. Additionally, in the illustrated embodiment a portion of the second surface 212 is carried on the tip of specimen 302. In other embodiments the specimen can have other arrangements. For example, in selected embodiments the specimen can be formed entirely from an internal portion of the structure 200. In still other embodiments, the specimen can include more or fewer surfaces/interfaces, including no interfaces (e.g., the specimen can include a homogeneous material).

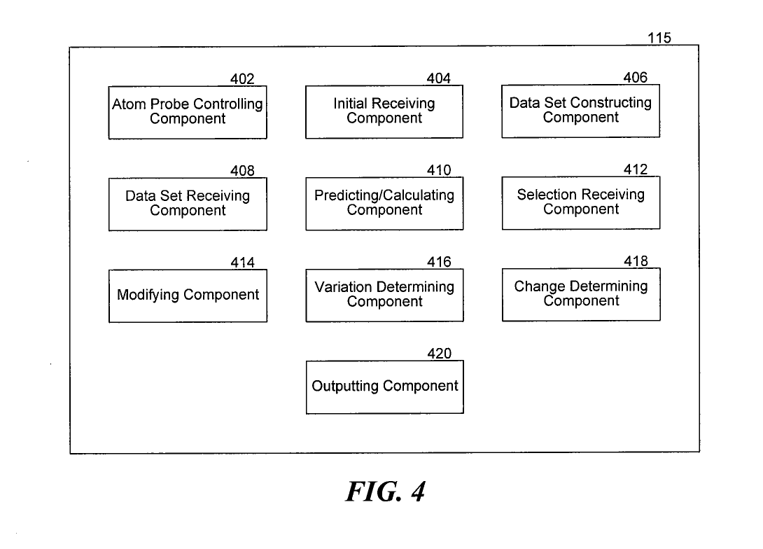

FIG. 4 is a partially schematic illustration of the computing system 115 shown in FIG. 1 in accordance with selected embodiments of the invention. In the illustrated embodiment, the computing system 115 includes an atom probe controlling component 402, and initial receiving component 404, a data set constructing component 406, a data set receiving component 408, a predicting/calculating component 410, a selection receiving component 412, a modifying component 414, a variation determining component 416, a change determining component 418, and an outputting component 420. In other embodiments, the computing system 115 can include more, fewer, and/or different components.

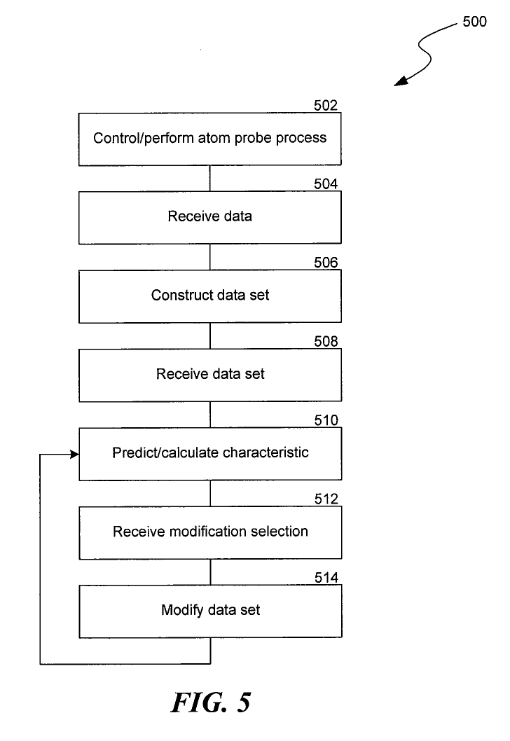

FIG. 5 is a flow diagram illustrating a method 500 for predicting one or more characteristics associated with an atom probe specimen in accordance with certain embodiments of the invention. In selected embodiments, various portions of the computing system 115 (shown in FIG. 4) can be used to carry out the method 500 shown in FIG. 5. For example, in the illustrated embodiment the atom probe controlling component 402 runs or controls an atom probe process (process portion 502) to evaporate atoms from a portion of the specimen and collect time of flight and position data for the evaporated atoms. For example, as atoms are evaporated from the specimen the controlling component 402 can track the order in which the atoms are evaporated and hit the detector (e.g., collect chronological data). The controlling component 402 can also track the position where the evaporated atoms impact the detector, discussed above with reference to FIG. 1 (e.g., the two-dimensional position data). Additionally, the time of flight data for the evaporated atom (e.g., the time it takes an evaporated atom to travel between the specimen and the detector) can be tracked by the controlling component 402. The chronological data, two-dimensional position data, time of flight data, and/or other data associated with the evaporation process (e.g., collectively referred to as data) can be stored, for example, in a list.

In selected embodiments, the controlling component 402 can send the data (e.g., chronological data, two-dimensional position data, time of flight data, and/or other data associated with the evaporation process) to the initial receiving component 404. The initial receiving component 404 can receive the data (process portion 504). In other embodiments, the controlling component 402 can provide the data for receipt by the initial receiving component 404 in another form or via another process. For example, in selected embodiments the controlling component 402 can provide an operator or user a print out of the data or the data stored on a computer readable medium (e.g., stored on a disk), for example, via the outputting component 420. The operator or user can then provide the data to the initial receiving component 404 via the computer readable medium (e.g., inserting the disk into the initial receiving component 404).

The initial receiving component 404 can provide the data to the data set constructing element 406. The data set constructing element 406 can construct a three-dimensional data set (process portion 506) from, or based on, the data received by the initial receiving component. For example, the three-dimensional data set can include a three-dimensional representation of the arrangement of atoms and/or molecules that were in/on the portion of the specimen before it was evaporated. For instance, in selected embodiments the three-dimensional data set can include a three-dimensional map, a three-dimensional array (e.g., numeric array), and/or the like.

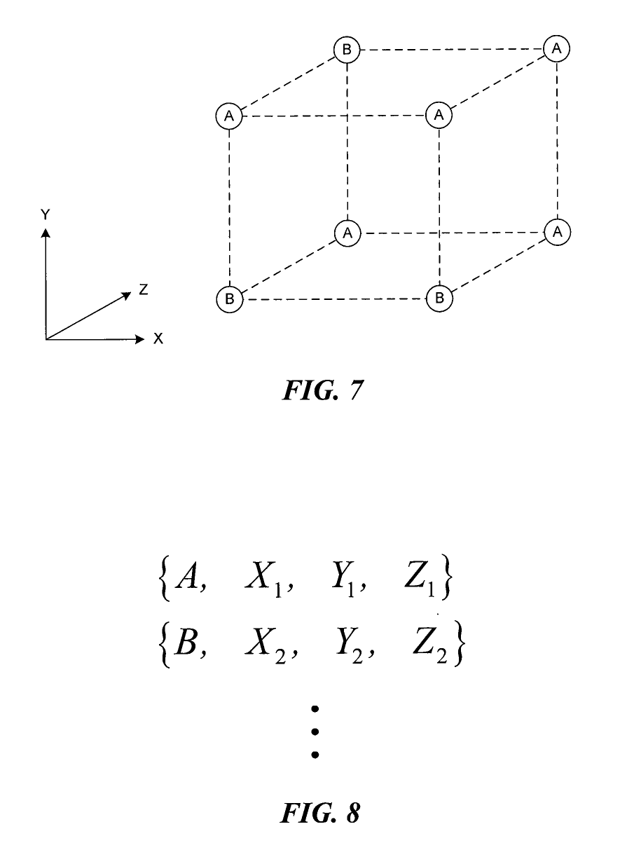

FIG. 7 is a partially schematic illustration of a three-dimensional map in accordance with selected embodiments of the invention. In FIG. 7, a portion of a structure is shown with two types of elements (e.g., atoms and/or molecules), shown as elements A and B. FIG. 8 is a partially schematic illustration of a portion of a three-dimensional numerical array representing a portion of the three-dimensional map shown in FIG. 7.

The data constructing component 406 can provide the data set to a data set receiving component 408 (e.g., via a network or a portable computer readable medium) and the data set receiving component 408 can receive the data set (process portion 508). The data set receiving component 408 can then provide the data set to the predicting/calculating component 410. The predicting/calculating component 410 can predict or calculate the one or more characteristics associated with at least part of the portion of the specimen using, or based on, the three-dimensional data set (process portion 510). For instance, the predicting/calculating component 410 can predict the one or more characteristics associated with at least part of the portion of the specimen wherein the one or more characteristics are different than the three-dimensional data set.

For example, because the data set includes the three-dimensional arrangement of atoms and/or molecules in at least part of the portion of the specimen (e.g., the data set includes the location and/or type/composition of the atoms and/or molecules in the portion of the specimen), the predicting/calculating component 410 can predict or calculate an electrical characteristic, a physical characteristic, and/or an operational characteristic associated with the arrangement of the atoms and/or molecules in the portion of the specimen. For instance, in certain embodiments the electrical characteristic can include conductivity between two regions or points in the specimen and the arrangement and/or concentration of a selected element (e.g., Boron atoms) between two regions/points in the specimen can be used to predict or calculate the conductivity between the two regions/points. Similarly, other electrical characteristics can be predicted or calculated including impedance, resistance, capacitance, inductance, charge states, magnetization, saturation magnetization, coercivity, polarizability, extinction coefficient, and/or the like.

In other embodiments, the predicting/calculating component 410 can predict or calculate operational characteristics for, or based on, the data set in a manner similar to that discussed above with respect to electrical characteristics. For example, in selected embodiments the specimen can include at least a portion of a transistor or gate parameter and the predicting/calculating component 410 can predict or calculate operational characteristics such as leakage current, threshold voltage, turn on slope, operating speed, current leakage, etc. In selected embodiments, this feature can be particularly useful for predicting why a selected element and/or microelectronic assembly has malfunctioned. For example, if a portion of microelectronic assembly has malfunctioned, portions of the assembly can be analyzed in an atom probe, a data set can be constructed, and the data set can be used to predict selected operational characteristics. This information can aid in understanding why the portion of the microelectronic assembly malfunctioned and/or what changes occurred to the structure of the malfunctioning portion of the microelectronic assembly to cause the malfunction.

In still other embodiments, the predicting/calculating component 410 can predict or calculate physical characteristics for, or based on, the data set in a manner similar to that discussed above with respect to electrical characteristics. For example, in selected embodiments the physical characteristics can include thermal conductivity, mass density/thickness, thermally-induced stress/strain, chemical phase identification, polarity, polarizability, hardness, mechanical strength, compliance, color, refractive index, friction coefficient(s), concentration gradients, impurity concentrations, and/or the like. In yet other embodiments, the physical characteristics can include various semiconductor parameters such as dopant concentration, average dopant histograms, and variations in dopants between areas. In still other embodiments, physical characteristics can include calculating a surface roughness metric, including interface metrics associated with buried or internal surfaces.

For example, in selected embodiment roughness metric can include a measure or roughness, diffusivity, and/or the like such as the American Society of Mechanical Engineers (“ASME”) B46 Surface Texture Standard. For instance, in the illustrated embodiment the predicting/calculation component 410 can predict or calculate a roughness metric from the data set for the first surface 208 of the first layer 204 and/or the first surface 210 of the second layer 206, and/or the interface 202 (shown in FIGS. 2 and 3). In selected embodiments, the predicting/calculating component 410 can identify at least one isosurface of the specimen (e.g., the first surface 208 of the first layer 204), for example, using a marching cube algorithm (see e.g., http://www.polytech.unice.fr/˜lingrand/MarchingCubes/alqo.html, which is fully incorporated herein by reference).

In certain embodiments, the predicting/calculating component 410 can then calculate a surface roughness metric associated with the identified isosurface based on the data set and the associated shape and position of the identified isosurface. For example, in selected embodiments voxel and delocalization sizes associated with the isosurface/data set can be selected and the roughness metric can be computed using statistical techniques (e.g., a root mean square method). Additionally, in certain embodiments the surface roughness metric of the isosurface can be used to determine a roughness metric of the interface 202. In other embodiments, a separate roughness metric can also be calculated for the first surface 210 of the second layer 206. In certain embodiments the roughness of internal surfaces and/or interfaces of a microelectronic assembly can be used to predict other characteristics associated with the assembly (e.g., operational and/or electrical characteristics). In other embodiments, a roughness metric can be predicted or calculated for other surfaces (e.g., surfaces that are exposed or carried on the exterior of the structure or specimen). For example, in selected embodiments a roughness metric can be calculated for the portion of the second surface 212 of the first layer 204 on the specimen 302 shown in FIG. 3.

In selected embodiments, once the predicting/calculating component 410 predicts or calculates one or more characteristics, the characteristic(s) can be provided to the outputting component 420 (e.g., via a network or a portable computer readable medium). The outputting component can then store the characteristic(s), display the characteristic(s), print the characteristic(s), and/or provide the characteristic to other components or other computing systems. For example, in certain embodiments iso-contours of materials can be displayed on a computer screen showing various layer interfaces and/or charge concentration for various regions can be displayed on a computer display wherein regions having different levels of charge are displayed in different colors. In still other embodiments, the characteristic can include identifying regions of the specimen associated with selected operational characteristics and the outputting component 420 can display features of, or symbols associated with, these operational characteristics. For example, selected regions can be displayed as portions of a transistor gates or an electrode.

In yet other embodiments, the computing system 115 can allow an operator to modify a data set and predict/calculate one or more characteristics associated with the modified data set. In selected embodiments, this feature can allow an operator to perform a “what if” analysis to predict the characteristics of a modified structure. For example, in certain embodiments one or more first characteristics can be predicted or calculated based on a data set, which has been constructed from data collected from an atom probe analysis process (e.g., as discussed above in various embodiments). An operator can provide a modification selection to the selection receiving component 412. The selection receiving component 412 can receive the modification selection (process portion 512) and provide the modification selection to the modifying component 414. The modifying component 414 can modify the data set based on the modification selection (process portion 514) and provide the modified data set to the predicting/calculating component 410. In selected embodiments, this predicting/calculating component 410 can receive the modified data set via the data set receiving component 408. The computing/calculating component 410 can predict/calculate a second characteristic based on the modified data set (process portion 510). Accordingly, in selected embodiments the affect of modifying the structure can be predicted and assessed using this feature without having to modify the actual structure.

For example, in one embodiment a density of Boron atoms in a silicon substrate can be determined based on a data set constructed from data collected during an atom probe analysis process performed on a specimen. Based on the data set, a first conductivity of a region of the specimen can be predicted or calculated and provided to an operator or user via the outputting component 420. The data set can then be modified to have an increased density of Boron atoms and a second conductivity can be predicted/calculated from the modified data set. The second conductivity can then be provided to the operator via the outputting component 420. In selected embodiments, this modification process can be repeated until a desired conductivity is at least approximately achieved.

In other embodiments, the operator can select a desired characteristic (e.g., a desired conductivity) via the selection receiving component and the computing system can run a repetitive or iterative modification process until the desired conductivity is at least approximately achieved (e.g., in a manner similar to that discussed above). For example, in certain embodiments the modifying component 414 can include logic for running/controlling the repetitive/iterative process. In other embodiments, other components can include at least a portion of the logic (e.g., software) to control the repetitive process. For example, in other embodiments the selection receiving component 412 can include at least a portion of the logic for running the repetitive modification process.

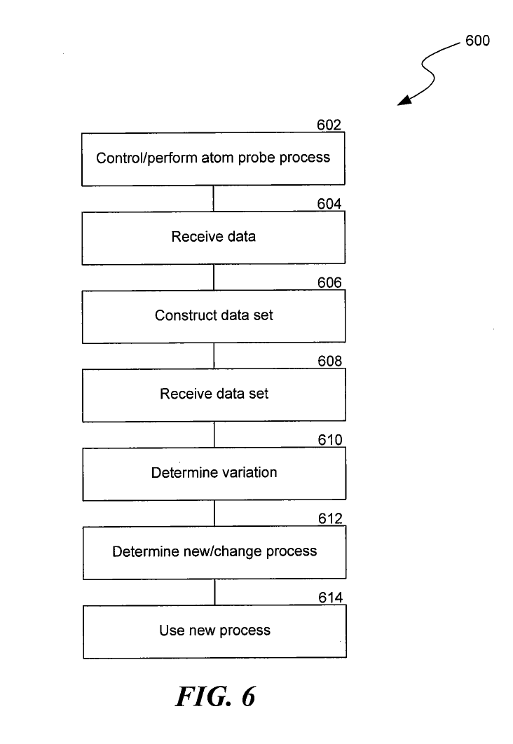

FIG. 6 is a flow diagram illustrating a method 600 for evaluating a manufacturing process using atom probe data in accordance with selected embodiments of the invention. In selected embodiments, evaluating a manufacturing process can include determining the variations between structures manufactured by the process and a selected configuration, qualifying a manufacturing process, evaluating the consistency of structures produced by a manufacturing process, evaluating the need for changes to a manufacturing process, evaluating the type of changes that are needed in a manufacturing process, changing a manufacturing process based on the variation between manufactured structures and a selected configuration, and/or the like. Although the manufacturing process can include any process for producing a structure (e.g., as shown in FIG. 2), in selected embodiments this feature can be particularly well suited for evaluating a manufacturing process used to produce a microelectronic assembly.

For example, in certain embodiments a manufacturing process for producing microelectronic assemblies is designed to produce semiconductor devices having a selected configuration (e.g., having various layers of materials and dopants). In some cases, the resulting microelectronic assemblies do not conform to the selected configuration. In other cases, the resulting microelectronic assemblies do not consistently conform to the selected configuration (e.g., some of the assemblies conform to the selected configuration and some do not). For example, in certain cases dopant atoms can form unanticipated clusters that can affect the performance of the microelectronic assembly. Additionally, in selected embodiments small changes in the manufacturing process (e.g., temperature, pressure, deposition processes, etc.) can have a significant effect on the resulting microelectronic assembly. Accordingly, in some embodiments it can be useful to use atom probe data to determine variations between the items produced by the manufacturing process and the selected configuration.

In selected embodiments, various portions of the computing system 115 (shown in FIG. 4) can be used to carry out the method 600 shown in FIG. 6. For example, a specimen can be formed from a portion of a structure (e.g., a microelectronic assembly) that has been produced by a manufacturing process. The atom probe controlling component 402 can control/perform an atom probe process on the specimen, the initial receiving component 404, and the data set constructing component 406 can provide a three-dimensional data set in a manner similar to that discussed above with reference to FIGS. 1-5. For example, the atom probe process can be controlled/performed on the specimen (process portion 602), the data can be received (process portion 604), and the data set can be constructed (process portion 606) in a manner similar to process portions 502-506, discussed above with reference to FIG. 5.

The data set receiving component can receive the data set (process portion 608) and provide the data set to the variation determining component 416 (e.g., via a network and/or a portable computer readable medium). The variation determining component 416 can determine a variation between the data set and a selected configuration expected to result from the manufacturing process (process portion 610). For example, in selected embodiments the data set can include a three-dimensional representation (e.g., map or array) of the atoms and/or molecules in a portion of the specimen and this three-dimensional representation can be compared to a three-dimensional representation of the configuration expected to result from the manufacturing process.

As discussed above, in selected embodiments the variation between the data set and the expected results can be used to qualify the production process, determine if the production process should be changed, etc. For example, in certain embodiments the variation determining component 416 can send the variation to the change determining component 418. The change determining component 418 can determine if the variation exceeds a selected value, determine if the manufacturing process needs to be changed, and/or determine the type of change that is needed to produce structures that is more similar to the expected configuration (process portion 612). For instance, in certain embodiments the change determining component 418 can determine a need for a change to a manufacturing process and/or the type of change needed based on the data set, the expected configuration, and/or data associated with the manufacturing process.

For example, in selected embodiments a data set can be constructed from atom probe data associated with analyzing a portion of a first microelectronic assembly that was produced via a first manufacturing process. The data set can be compared to a configuration that is expected to result from the first manufacturing process to determine a first variation. The change determining component 418 can determine whether a change is needed to the manufacturing process based on the first variation. If the change determining component 418 determines a change is needed, the change determining component 418 can determine a second manufacturing process (e.g., a modification of the first manufacturing process and/or an entirely new process) that is expected to provide a second microelectronic assembly that includes a portion that has a second variation from the selected configuration where the second variation is less than the first variation (e.g., where the portion of the second microelectronic assembly is more similar to the expected configuration than the first microelectronic assembly).

In selected embodiments, the change determining component 418 can provide the second manufacturing process to the outputting component 420 (e.g., via a network or a portable computer readable medium). The outputting component 420 can receive the second manufacturing process and provide the second manufacturing process (e.g., the change from the first manufacturing process) to an operator or user via a display and/or printout. In other embodiments, the second manufacturing process can be stored or provided to another system (e.g., via a network or a portable computer readable medium). For example, in certain embodiments the second manufacturing process can be provided to a computer controlling the manufacturing of the structures so that the computer changes from using the first manufacturing process for making structures to the second manufacturing process (process portion 614). In other embodiments, the outputting component 420 can receive information associated with the variation between the portion of the first microelectronic assembly and the expected configuration and/or between predicted variation between the portion of the second microelectronic assembly and the expected configuration.

In other embodiments, multiple specimens from multiple portions of a selected structure and/or from multiple structures produced by a selected manufacturing process can be used to produce multiple data sets. Variation between each data set and its corresponding expected configuration can be determined. The variations can be used in a manner similar to that discussed above to qualifying the selected manufacturing process, to evaluate the consistency of structures produced by the selected manufacturing process, to evaluate the need for changes to the selected manufacturing process, to evaluate the type of changes that are needed in the selected manufacturing process, etc.

Many of the embodiments discussed above can have other arrangements and/or be practiced in other ways. For example, in selected embodiments features of the method shown in FIG. 5 and the method shown in FIG. 6 can be combined. Additionally, although various outputs provided by the outputting component 420 have been described, in other embodiments the outputting component 420 can provide information to a user or another system (e.g., another computing system) concerning other features and/or process portions. Additionally, although many of the process portions have been described as computer implemented process portions, in other embodiments some or all of the processes can be accomplished, at least in part, manually. Furthermore, as discussed above, while FIG. 1 shows an atom probe with a local electrode, in other embodiments, other types of atom probes can be used (e.g., atom probes with other types of electrodes). However, in selected embodiments an atom probe having a local electrode can be well suited for use with some of the process discussed above because of the resolution and/or field of view provided by such a device. For example, in certain embodiments an atom probe similar to those described in U.S. Pat. No. 5,440,124, issued Aug. 8, 1995, entitled HIGH MASS RESOLUTION LOCAL-ELECTRODE ATOM PROBE, which is fully incorporated herein by reference, can be well suited for use with some of the process discussed above.

From the foregoing, it will be appreciated that specific embodiments of the invention have been described herein for purposes of illustration, but that various modifications may be made without deviating from the invention. Additionally, aspects of the invention described in the context of particular embodiments may be combined or eliminated in other embodiments. Although advantages associated with certain embodiments of the invention have been described in the context of those embodiments, other embodiments may also exhibit such advantages. Additionally, not all embodiments need necessarily exhibit such advantages to fall within the scope of the invention. Accordingly, the invention is not limited except as by the appended claims.

I/We claim:

1. A computing system configured to predict a characteristic associated with an atom probe specimen, comprising:
a data set receiving component configured to receive a three-dimensional data set, the three-dimensional data set being based on data collected from performing an atom probe process on a portion of the specimen; and
a predicting/calculating component configured to predict the characteristic associated with at least part of the portion of the specimen based on the three-dimensional data set, the characteristic being different than the three-dimensional data set.

2. The system of claim 1, further comprising:
an atom probe controlling component configured to control an atom probe process to (a) evaporate atoms from the portion of the specimen and (b) collect time of flight and position data for the evaporated atoms;
an initial receiving component configured to receive the time of flight and position data; and
a data set constructing element configured to construct the three-dimensional data set from the time of flight and position data, the three-dimensional data set being a three-dimensional array.

3. The system of claim 1, further comprising:
an atom probe controlling component configured to control an atom probe process to (a) evaporate atoms from the portion of the specimen and (b) collect chronological data, two-dimensional position data, and time of flight data for the evaporated atoms;
an initial receiving component configured to receive the chronological data, two-dimensional position data, and time of flight data; and
a data set constructing element configured to construct the three-dimensional data set from the chronological data, two-dimensional position data, and time of flight data.

4. The system of claim 1 wherein the characteristic includes at least one of an electrical characteristic, a physical characteristic, and an operational characteristic.

5. The system of claim 1 wherein the characteristic includes a metric associated with the roughness of a surface, the surface being an exposed surface or buried surface prior to the atom probe process.

6. The system of claim 1 wherein the specimen includes a portion of a microelectronic assembly.

7. The system of claim 1 wherein the portion of the specimen includes a malfunctioning portion of a microelectronic assembly and the characteristic includes a characteristic associated with the operation of the microelectronic assembly.

8. The system of claim 1 wherein the characteristic includes a first characteristic, and wherein the system further comprises a modifying component configured to modify the three-dimensional data set; and wherein the predicting/calculating component is configured to predicting a second characteristic based on the modified three-dimensional data set.

9. The system of claim 1 wherein the characteristic is a first characteristic, and wherein the method further comprises:
a selection receiving component configured to receive a modification selection, the modification selection including a second characteristic; and
a modifying component configured to modify the three-dimensional data set until the second characteristic is at least approximately predicted by the predicting/calculating component.

10. A computing system configured to calculate a surface roughness metric associated with a specimen, comprising:
a data set receiving component configured to receive a three-dimensional data set, the three-dimensional data set being based on data collected from performing an atom probe process on a portion of the specimen; and
a calculating component configured to calculate the surface roughness metric associated with a surface of the specimen based on the three-dimensional data set.

11. The system of claim 10 wherein the surface includes surface carried in the interior of the specimen prior to the atom probe process.

12. The system of claim 10 wherein the surface includes an exterior surface of the specimen prior to the atom probe process.

13. The system of claim 10 wherein the surface includes a first surface and the specimen carries a second surface abutting the first surface to form an interface between two layers of the specimen.

14. The system of claim 10, further comprising:
an atom probe controlling component configured to control an atom probe process to (a) evaporate atoms from the portion of the specimen and (b) collect time of flight and position data for the evaporated atoms;
an initial receiving component configured to receive the time of flight and position data; and
a data set constructing element configured to construct the three-dimensional data set from the time of flight and position data, the three-dimensional data set being a three-dimensional array.

15. The system of claim 10 wherein calculating the surface roughness metric includes identifying an isosurface of the specimen and calculating the surface roughness metric associated with the isosurface of the specimen based on the three-dimensional data set.

16. A method for evaluating a manufacturing process using atom probe data, comprising:
receiving a three-dimensional data set, the three-dimensional data set being based on data collected from performing an atom probe process on a portion of a specimen, the specimen being a portion of a microelectronic assembly produced by a manufacturing process;
determining a variation between the three-dimensional data set and a selected configuration expected to result from the manufacturing process.

17. The method of claim 16 wherein the microelectronic assembly includes a first microelectronic assembly, and wherein the method further comprises determining a change to the manufacturing process that will provide a second microelectronic assembly that has a portion that is more similar to the selected configuration than the first microelectronic assembly.

18. The method of claim 16 wherein the microelectronic assembly includes a first microelectronic assembly, and wherein the method further comprises:
determining a change to the manufacturing process that will provide a second microelectronic assembly that has a portion that is more similar to the selected configuration than the first microelectronic assembly; and
making the change to the manufacturing process.

19. The method of claim 16 wherein the microelectronic assembly includes a first microelectronic assembly, the manufacturing process includes a first manufacturing process, and the variation includes a first variation, and wherein the method further comprises determining a second manufacturing process that is expected to provide a second microelectronic assembly that includes a portion that has a second variation from the expected configuration, the second variation being less than the first variation.

20. The method of claim 16, further comprising:
performing an atom probe process on the portion of the specimen to collect time of flight and position data for atoms evaporated by the atom probe process; and
constructing the three-dimensional data set from the time of flight and position data, the three-dimensional data set being a three-dimensional array.
